(19) United States
(12) Patent Application Publication
(10) Pub. No.: US 2004/0116570 A1
(43) Pub. Date: Jun. 17, 2004

(54) Additives for use in a water-soluble polymer dispersion for treating wood or wood products

(76) Inventors: Thomas Staffel, Grunstadt (DE); Michael Schmitt, Heidelberg (DE); Wernfried Heilen, Alpen (DE); Markus Hoschke, Mulheim (DE)

Correspondence Address: VENABLE, BAETJER, HOWARD AND CIVILETTI, LLP, P.O. BOX 34385, WASHINGTON, DC, 20043-9998, US

(21) Appl. No.: 10/469,311

(22) PCT Filed: Mar. 1, 2002
(86) PCT No.: PCT/EP02/02208

(30) Foreign Application Priority Data
Mar. 2, 2001 (DE) 10110160.0

(51) Int. Cl. C08K 5/04

(52) U.S. Cl. 524/394

(57) ABSTRACT

The invention relates to the use of an additive in an aqueous polymer dispersion which is used in the treatment of wood or wood products. Wood is treated in the form of a filler or covering and the aim thereof is to prevent discharge of the materials contained in the wood. A water-soluble titanium chelate compound was tested for such a purpose and had good results.

The invention relates to the use of an additive in an aqueous polymer dispersion, which is used for the treatment of wood or wood products. The treatment of wood in this case takes the form of a priming coat and/or coating and is primarily intended to prevent the discharge of components in the wood.

Many types of wood used in the wood industry contain larger or smaller amounts of wood components that are undesirable for the processing as well as for the later use. Above all, these wood components are lignin and tannin, which are contained in larger amounts in wood from trees such as oak, red cedar, and Merbau¹. These components become visible on the wood surface as spots when the wood is subjected to humidity and, above all, increased temperatures, but always during the processing of the wood for industrial or trade purposes and also during the later use of the object fashioned from wood. To prevent this, the wood surface must be treated with a top coating and a priming material and provided with a sealer. ¹Merbau=special wood from Southeast Asia with botanical name “Intsia spp.” which is used for wood flooring

Spots can also form on other backgrounds if these contain building materials made from wood processing byproducts. Examples to be mentioned in this case are wood-fiber boards and sandwich-type plaster boards because tannin-like substances can also be released from their surfaces and become visible in the form of yellow spots on the white plasterboard surface.

To prevent these undesirable appearances, priming coats that function as sealing layers are applied before the top coating is applied. As a rule, binding agents are used that are based on polyurethanes or epoxy resins and contain solvents, for example as disclosed in reference EP 0 420 293. The disadvantages of these applications involve long drying times, the solvent content and, finally, the additional processing step that is required as a result of the prior application.

Improvements were achieved in recent years in that specific metal compounds, for example containing chromium, tungsten, boron and molybdenum ions, are added to the colors and also the binding agents. However, the metal compounds used herein are questionable from a toxicological point of view. A metal compound group of this type is described in the U.S. Pat. No. reference A 3,847,857.

An aqueous dispersion containing a zirconium salt is disclosed in the EP reference 709 441 B1 for that purpose. According to claim 5, this dispersion contains up to 97 to 70 weight % of an emulsion polymer and the water-soluble zirconium compound in amounts of 0.2 to 20 weight % (in the form of ZrO₂), as referred to the dispersion. These zirconium compounds, however, must be stabilized with an ammonium compound because of the low pH value, so as to be compatible with the other dispersion components.

The object therefore continues to be to find more compatible additives which can be added to standard dispersions for primers or coatings, are compatible with the components of these dispersions, and are chemically stable.

This object is solved with by using the water-soluble titanium compounds according to claims 1 and 2.

Based on this, the additive according to the invention is a water-soluble titanium compound. The water-soluble titanium compounds to be considered are the complex titanium chelates with an organic alpha hydroxy carbolic acid as ligand, for example the lactic acid. Particularly preferred as titanium compound is a titanium lactate with the chemical designation Titanat (2)dihydroxybis[2-hydroxypropanato (2)-diammonium. This titanium compound is added to the aqueous synthetic dispersion used for priming or coating wood surfaces and other backgrounds that have a tendency to bleed. The titanium compound as aqueous solution can be metered directly into the synthetic dispersions or into systems based thereon.

The preferred amount of titanium compound used for the primers preferably is 0.2 to 20 weight %, in particular 0.5 to 10 weight % and especially preferred 1 to 5 weight %, in the form of titanium oxide TiO₂ and referred to the aqueous synthetic dispersion.

The additive according to the invention has the following advantages:

The titanium compound has a neutral pH value.

The titanium compound forms a thin titanium dioxide layer in the dispersion.

Titanium dioxide, however, is simultaneously known as white pigment and thus contributes especially to the optical brightening of the applied coating.

The additive according to the invention is water soluble.

It is used in the form of an aqueous solution and does not require organic solvents.

As a result of the neutral pH value of the titanium compound, this compound is compatible with the components that normally are part of a dispersion color. No flocculation or separating out reduces the good wearing qualities of the synthetic dispersion produced therewith.

The invention is further illustrated, without being restricted, with the aid of the following tables and examples, without restricting it:

### EXPERIMENTAL FORMULATIONS

The experiments were carried out on the basis of the following binding agents:

Acronal S 726: a styrene-acrylate dispersion

Mowilith LDM 6150 (48% FK): plasticizer-free, aqueous dispersion on the basis of acrylic acid ester and styrene

Formulas for the Experimental Coatings

The two binding agents were initially tested in two different formulations, without the dispersion according to the invention.

TABLE 1

| | ex- | ex- | ex- | ex- | ex- | ex- |
|---|---|---|---|---|---|---|
| | ample | ample | ample | ample | ample | ample |
| sealer coat | 1 | 2 | 3 | 4 | 5 | 6 |
| VE water | 10.0 | 10.1 | 10.0 | 10.0 | 10.0 | 10.0 |
| TEGO ® Dispers | 1.0 | 1.0 | 1.0 | 1.0 | 1.0 | 1.0 |
| 745 W | | | | | | |
| Acrysol RM 8 | 0.5 | 0.5 | 0.5 | 0.5 | 0.5 | 0.5 |
| Kronos 2059 | 15.0 | 15.0 | 15.0 | 15.0 | 15.0 | 15.0 |
| Omyacarb 2 GU | 15.0 | 15.0 | 15.0 | 15.0 | 15.0 | 15.0 |
| butyl glycol | 5.0 | 5.0 | 5.0 | 5.0 | 5.0 | 5.0 |
| TEGO ® Wet 265 | 0.5 | 0.5 | 0.5 | 0.5 | 0.5 | 0.5 |
| inventive titanium | — | — | 5.0 | 5.0 | — | — |
| compound | | | | | | |
| Titanbit, compound | — | — | — | — | 3.0 | 3.0 |
| acc. to prior art | | | | | | |
| Acronal 726 | 50.0 | — | 50.0 | — | 50.0 | — |
| Mowilith LDM 6150 | — | 50.0 | — | 50.0 | — | 50.0 |
| VE water | 3.0 | 3.0 | — | — | — | — |
| Sum total: | 100.0 | 100.0 | 100.0 | 100.0 | 100.0 | 100.0 |

The product names used in the tables are added in the form of a legend to this description.

Application and Testing of the Formulations

The finished coating materials were applied with a wet-layer thickness of approximately 100 g/m² onto the test boards by using a high-pressure spray gun. This was done to avoid errors when applying the coating materials, i.e. relating to the non-optimized degassing and the like.

The product was initially dried for 30 minutes at room temperature and subsequently for 60 minutes at 40° C.

The boards were provided with one or two coats of the primer. The cover coat of enamel (white, satin finish) was subsequently applied to the complete board with the aid of a high-pressure spray gun. The application amount again was approximately 100 g/m².

TABLE 2
Formulations for white satin finish enamel

| | W [%] |
|---|---|
| VE water | 10.0 |
| Acrysol RM 8 | 0.3 |
| TEGO ® Dispers 745 W | 1.0 |
| Aerosil 972 | 1.0 |
| Kronos 2059 | 17.5 |
| TEGO ® Foamex 800 | 0.5 |
| Alberdingk APU 1061 | 60.0 |
| Dowanol DPnB | 3.0 |
| VE water | 6.7 |
| Sum Total: | 100.0 |

Coating Composition

Two-layer composition three-layer composition

Top enamel coat on the basis of Alberdingk APU 1061 (approx. 100 g/m²)

Sealer (approx. 100 g/m²)

Background is oak peeled veneer on 9 mm particle board

TABLE 3
Results of the experiments

| | | two-layer composition | | | | three-layer composition | | | |
|---|---|---|---|---|---|---|---|---|---|
| No. | binder | ΔL | Δa | Δb | ΔE | ΔL | Δa | Δb | ΔE |
| Example 1 | Acronal | −0.51 | −0.08 | +0.60 | 0.79 | −0.11 | −0.06 | +0.81 | 0.82 |
| without additive | 726 | | | | | | | | |
| Example 2 | Mowilith | −0.26 | −0.04 | +1.09 | 1.12 | +0.09 | +0.01 | +0.68 | 0.69 |
| without additive | 6150 | | | | | | | | |
| Example 3 | Acronal | −0.46 | −0.10 | +0.60 | 0.76 | −0.01 | −0.10 | +0.99 | 1.00 |
| inventive titanium | 726 | | | | | | | | |
| compound | | | | | | | | | |
| Example 4 | Mowilith | −0.54 | −0.16 | +1.59 | 1.69 | −0.52 | −0.15 | +1.14 | 1.55 |
| inventive titanium | 6150 | | | | | | | | |
| compound | | | | | | | | | |
| Example 5 | Acronal | −0.63 | −0.04 | +0.69 | 0.94 | −0.14 | +0.03 | +0.32 | 0.35 |
| with Titanbit | 726 | | | | | | | | |
| Example 6 | Mowilith | −0.06 | +0.03 | +0.78 | 0.78 | −0.04 | +0.07 | +0.91 | 0.91 |
| with Titanbit | 6150 | | | | | | | | |

TABLE 4
Results for the two-layer composition

| | | | two-layer composition | | | |
|---|---|---|---|---|---|---|
| No. | binding agent | | ΔL | Δa | Δb | ΔE |
| Example 3 | Acronal | S | −0.46 | −0.10 | +0.60 | 0.76 |
| inventive titanium | 726 | | | | | |
| compound | | | | | | |
| Example 1 | Acronal 726 | S | −0.51 | −0.08 | +0.60 | 0.79 |
| without additive | | | | | | |
| Example 6 | Mowilith | | −0.06 | +0.03 | +0.78 | 0.78 |
| with Titanbit | 6150 | | | | | |
| Example 2 | Mowilith | | −0.26 | −0.04 | +1.09 | 1.12 |
| without additive | 6150 | | | | | |

TABLE 5
Results for the three-layer composition

| | | three-layer composition | | | |
|---|---|---|---|---|---|
| No. | binding agent | ΔL | Δa | Δb | ΔE |
| Example 5 | Acronal 726 | −0.14 | +0.03 | +0.32 | 0.35 |
| with Titanbit | | | | | |
| Example 1 | Acronal 726 | −0.11 | −0.06 | +0.81 | 0.82 |
| without additive | | | | | |

Results of the Experiments

The best results were achieved with the two products involving the titanium compound according to the invention and Titanbit. The changes were for the total color tone (ΔE—values).

The products used for the experiments, mentioned with their trade names herein, are as follows:

1. TEGO Dispers 745 W dispersing agent on the basis of a moderate poly acrylate with pigment-affinitive groups

2. Acrylsol RM 8 thickening agent on polyurethane base

3. Kronos 2059 TiO₂ pigment

4. Omyacarb2 GU precipitated out calcium carbonate

5. TEGO Wet 265 substrate wetting agent

6. Acronal S 726 styrene acrylate dispersion

7. Mowilith LDM 6150 plasticizer-free aqueous dispersion on the basis of acrylic acid ester and styrene

8. Aerosil 972 pyrogenic silicic acid

9. TEGO Foamex 800 foam separator

10. Alberdingk APU 1061 urethane-acrylate polymer

11. Dowanol DPNB film-forming auxiliary agent

12. Titanbit ammonium titanyl sulfate

1. The use of an aqueous titanium chelate compound as additive in aqueous polymer dispersions for the treatment of wood and wood products.

2. The use according to claim 1, characterized in that a titanium lactate is used as aqueous titanium chelate compound, namely Titanat (2)-dihydroxybis-[2-hydroxypropanato(2)-diammonium in amounts of 0.2 to 20 weight %, preferably 0.5 to 10 weight % and especially preferred 1 to 5 weight % in the form of titanium oxide TiO₂ and referred to the aqueous polymer dispersion.
